(19) United States
(12) Patent Application Publication
(10) Pub. No.: US 2001/0027955 A1
(43) Pub. Date: Oct. 11, 2001

(54) Crane vehicle

(76) Inventor: Hans-Dieter Willim, Ulm (DE)

Correspondence Address: Rocco S. Barrese, Esq., Dilworth & Barrese, LLP, 333 Earle Ovington Blvd., Uniondale, NY, 11553, US

(21) Appl. No.: 09/791,283

(22) Filed: Feb. 23, 2001

(30) Foreign Application Priority Data
Feb. 25, 2000 (DE) 200 03 490.1

(51) Int. Cl. B66C 23/72

(52) U.S. Cl. 212/178

(57) ABSTRACT

A crane vehicle is provided with a carrier and a rotating deck pivotable around a vertical axis thereon on which a boom swivellable around a horizontal axis is supported. Pallets are mounted at the projecting outer end of the rotating desk at both sides to receive counterweight slabs stacked on top of one another. To produce a greater balancing counter-moment to the boom and the load suspended thereon without putting on additional counterweight slabs, a frame can be attached to the outer end of the rotating deck, said frame being provided with accommodations or couplings at least for the respective rear suspension points of the pallets.

The invention relates to a crane vehicle having a carrier and a rotating deck pivotable around a vertical axis thereon on which a boom swivellable around a horizontal axis is supported and at whose projecting, outer end pallets are mounted at both sides to receive counterweight slabs stacked on top of one another. In this crane vehicle, the projecting outer end of the rotating deck forms a counter-boom, so to speak, at which the counterweight is mounted to balance the boom and the load suspended thereon. If a larger counterweight is required to balance the boom and the load carried thereby, further counterweight slabs are normally placed on the stacked counterweight slabs. This is, however, relatively expensive because the additional counterweight slabs have to be transported and kept available.

It is therefore the object of the invention to produce a greater balancing counter-moment in a crane vehicle of the kind first mentioned without placing on additional counterweight slabs.

This object is solved in accordance with the invention by a frame being attachable to the outer end of the rotating deck, said frame being provided with accommodations or couplings at least for the respective rear suspension points of the pallets.

In the crane vehicle in accordance with the invention, the balancing moment is increased by the lever arm, at which the counterweight acts, being extended. This is achieved by the pallets supporting the stacked counterweight slabs being offset to the rear with respect to the rotating deck.

The frame extending the rotating deck to the rear can accept in each case one suspension point of the pallets or, however, also all suspension points of the pallets.

The suspension points can consist of bolt connections or hook connections.

A simple attachment of the pallets extending the lever arm is possible by the pallets being connectable by suspension devices situated at their side parts to counter-accommodations of the rotating deck and by the inner suspension devices of the pallets being able to be coupled to the outer counter-accommodations when the frame is attached. The inner suspension points of the pallets can in this way be coupled to the already present end counter-accommodations of the rotating deck so that the attached frame then only has to be provided with counter-accommodations for the outer suspension points of the pallets.

It is provided in accordance with another embodiment that the frame is provided with two accommodations or couplings for in each case two side suspension points of the pallet.

The suspension points can consist of bolt connections or hook connections.

The pallets are appropriately able to be coupled in the same manner to both the rotating deck and the frame which can be attached thereto. The pallets are therefore able to be coupled to counter-accommodations of the rotating deck by bolt or hook connections located at the side parts of said pallets, with the inner bolts or hook connections of the pallets being able to be coupled to the outer counter-accommodations of the rotating deck when the frame is attached.

It is provided in accordance with another aspect that the two pallets are connected to one another by a central intermediate piece connectable to the frame. In this embodiment, the side pallets are connected by the central intermediate piece to form a continuous slab or carrier, so to speak, whose central region is connected to the frame so that the parts of the carrier projecting over the frame at the side form the pallet-like accommodations for the counterweight slabs.

It can be appropriate in certain operating states to design the value of the stabilising counter-moment variably. In accordance with another embodiment, it is therefore provided for the counterweight slabs to be displaceable with the positioned counterweight slabs on guides of the rotating deck. The lever arm, at which the counterweight acts, can therefore be adjusted to the different load cases by a corresponding displacement of the trolleys or slides bearing the counterweight slabs, for example by hydraulic cylinders.

An embodiment of the invention is described in more detail below with reference to the drawing in which

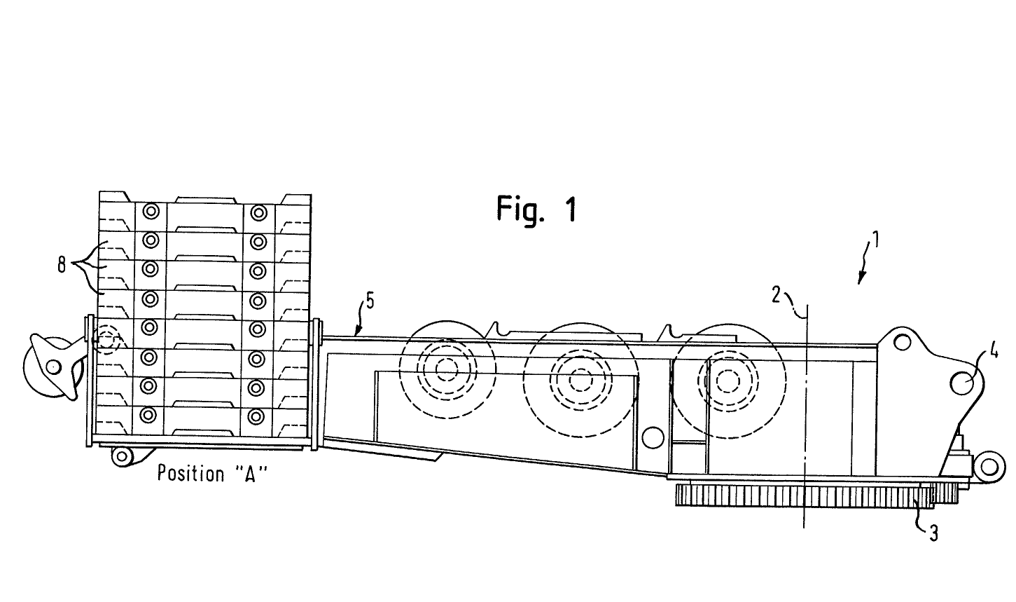

FIG. 1 shows a side view of a rotating deck released from a carrier and having pallets mounted at the sides and bearing stacked counterweight slabs;

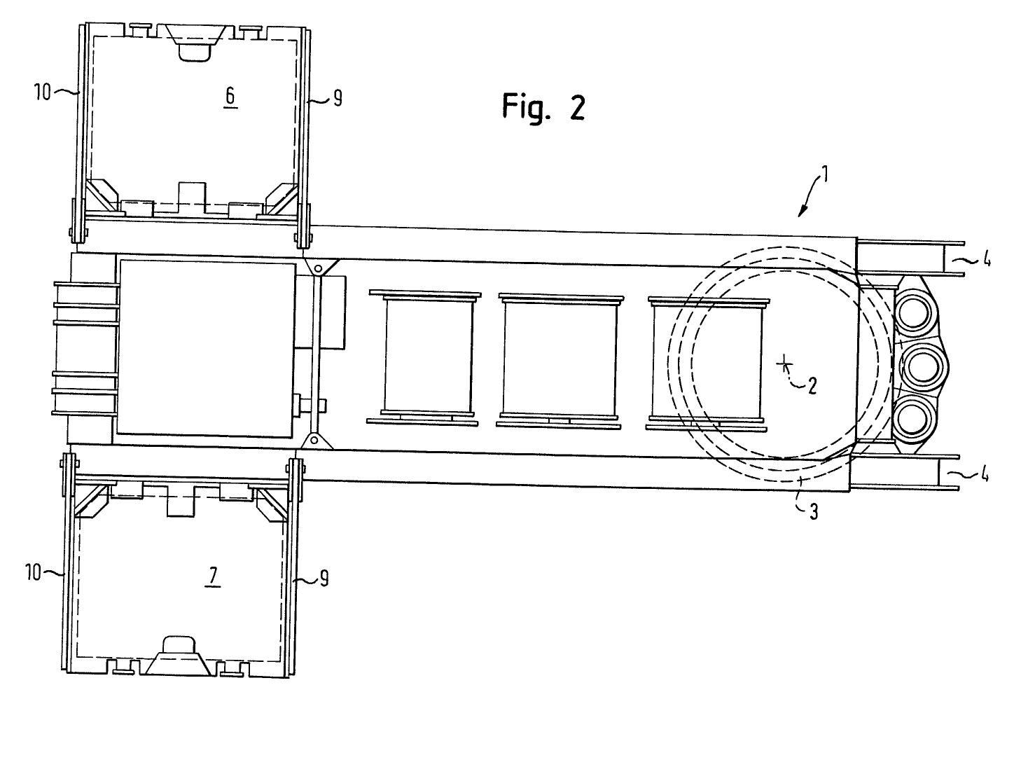

FIG. 2 shows a plan view of the rotating deck in accordance with FIG. 1;

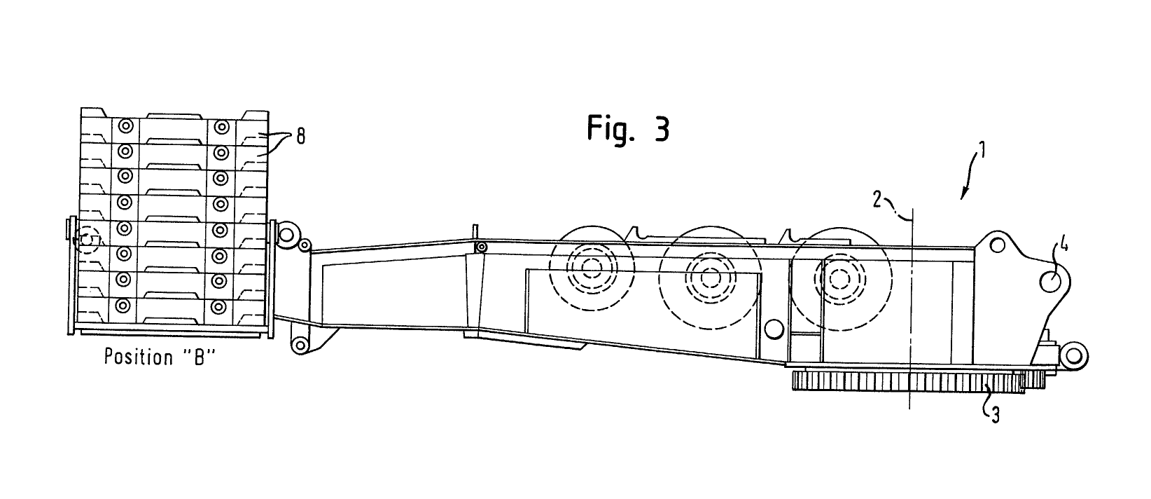

FIG. 3 shows a representation corresponding to FIG. 1 in which a frame is attached to the rear end of the rotating deck, said frame bearing the rear end of the side pallets having the counterweight slabs placed thereon;

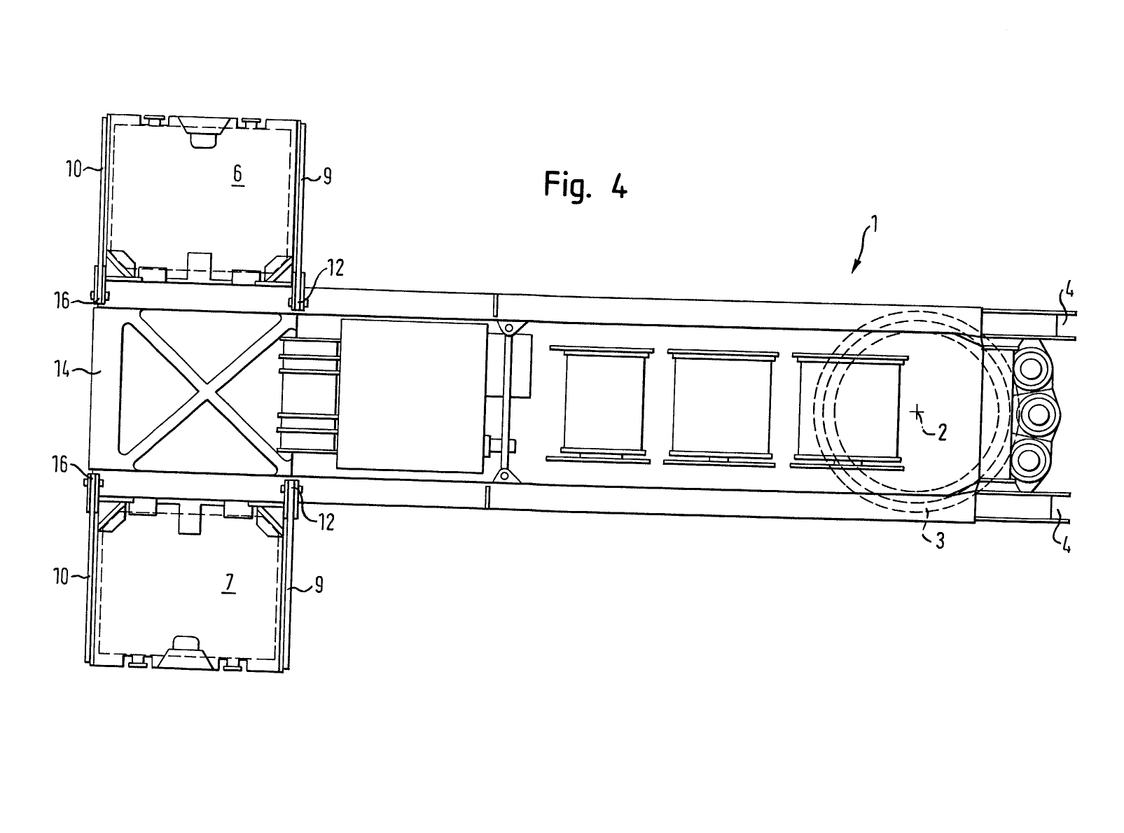

FIG. 4 shows a plan view of the rotating deck in accordance with FIG. 3; and

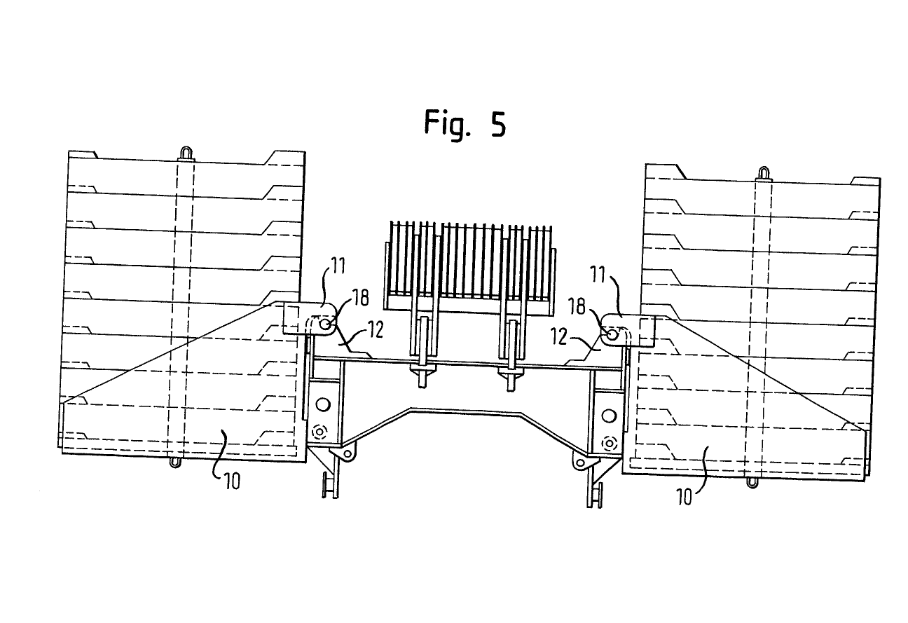

FIG. 5 shows a rear view of the rotating deck in accordance with FIG. 1.

The revolving superstructure or rotating deck 1 is pivoted via a pivot bearing (not shown) around the vertical axis of rotation 2 on a self-propelled carrier (not shown). The rotating deck 1 is provided with a rotary drive of which only the toothed turntable 3 is shown. The rotating deck is provided at its front end with bearings 4 in which the boom is pivoted on a horizontal axis of swivel.

Winches and drive units are mounted in the rotating deck I in the normal manner.

At the rear end 5 of the rotating deck, pallets 6, 7 are mounted at its sides and counterweight slabs 8 are stacked on said pallets 6, 7. The ground slabs of the pallets 6, 7 are borne in the manner visible from FIG. 5 by front or side walls 9, 10 which are provided at their upper inner ends with projecting fork-like shackles 11 which are connected to one another in the region of their outer ends by transverse bolts 18 to form hook-like eyes which can be hooked to uprising counter-hooks 12 which are arranged at the side of the rotating deck 11. The floor regions of the pallets can be supported in the manner shown on side parts of the rotating deck or of the frame attached thereto.

To extend the lever arm at which the counterweight slabs act, the pallets 6, 7 can be offset to the rear by the attachment of a frame 14 to the rear end of the rotating deck 1 in the manner visible from FIGS. 3 and 4, with the frame 14 approximately corresponding to the width of the slabs and with the frame only being provided with counter-accommodations 12 at its rear end, said counter-accommodations 12 corresponding to the corresponding counter-accommodations of the rotating deck 1. This embodiment allows the inner side walls 9 of the pallets to be connected or hooked to the end counter-accommodations 12 of the rotating deck 1, while the outer side walls 12 of the pallets 6, 7 are connected or hooked in the same way to the identically designed counter-accommodations 16 at the outer end of the frame 14, as before to the side counter-accommodations of the rotating deck.

1. a crane vehicle having a carrier and a rotating deck (1) pivotable around a vertical axis thereon on which a boom swivellable around a horizontal axis is supported and at whose projecting, outer end pallets (6, 7) are mounted at both sides to receive counterweight slabs (8) stacked on top of one another,
characterised in that
a frame (14) is attachable to the outer end of the rotating deck (1), said frame (14) being provided with accommodations or couplings at least for the respective rear suspension points of the pallets (6, 7).

2. A crane vehicle in accordance with claim 1, wherein the frame (14) is provided with two accommodations or couplings for respectively two side suspension points of the pallets (6, 7).

3. A crane vehicle in accordance with either of claims 1 or 2, wherein the suspension points consist of bolt connections or hook connections (11, 12, 18).

4. A crane vehicle in accordance with any of claims 1 to 3, wherein the pallets (6, 7) can be coupled to counter-accommodations of the rotating deck (1) by bolt or hook connections located at the side parts of said pallets and wherein the inner bolt or hook connections of the pallets can be coupled to the outer counter-accommodations of the rotating deck (1) when the frame (14) is attached.

5. A crane vehicle in accordance with any of claims 1 to 4, wherein the outer end of the frame (14) is provided with identical counter-accommodations for coupling to the outer connecting devices of the pallets (6, 7).

6. A crane vehicle in accordance with claim 1, wherein the two pallets are connected to one another by a central intermediate piece connectable to the frame.

7. A crane vehicle in accordance with any of claims 1 to 6, wherein the pallets bearing the counterweight slabs are arranged longitudinally displaceably with respect to the rotating deck.
